(19) United States
(12) Patent Application Publication
(10) Pub. No.: US 2016/0079014 A1
(43) Pub. Date: Mar. 17, 2016

(54) ROTATIONAL OPERATION TYPE SWITCH

(71) Applicants: FUJI ELECTRIC FA CONPONENTS & SYSTEMS CO., LTD., Tokyo (JP); CHICHIBU FUJI CO., LTD., Chichibu-gun (JP)

(72) Inventors: Yoshihiro TAKANO, Kounosu-shi (JP); Noriyoshi MACHIDA, Kounosu-shi (JP)

(21) Appl. No.: 14/936,115

(22) Filed: Nov. 9, 2015

Related U.S. Application Data
(63) Continuation of application No. PCT/JP2014/061022, filed on Apr. 18, 2014.

(30) Foreign Application Priority Data
Jun. 21, 2013 (JP) 2013-130782

(51) Int. Cl. H01H 19/58; H01H 19/14; H01H 19/11

(52) U.S. Cl. CPC H01H 19/585; H01H 19/11; H01H 19/14

(57) ABSTRACT

A rotational operation type switch includes a frame; a rotational operation button rotatably supported on the frame for rotational operation; a switching contact mechanism disposed below the operation button to face the operation button; and an operation mechanism disposed between the operation button and the switching contact mechanism, to switch the switching contact mechanism in conjunction with the rotational operation of the operation button. The switching contact mechanism includes a printed circuit board, a plurality of fixed contact electrodes disposed on the printed circuit board and spaced a predetermined distance away from each other, and a movable contact having a disc spring shape and disposed bridging between the plurality of fixed contact electrodes. The movable contact deforms to contact and separate from the fixed contact electrodes and switches an electrical connection between the fixed contact electrodes.

### CROSS-REFERENCES TO RELATED APPLICATIONS

The present application is a Continuation application of PCT International Application No. PCT/JP2014/061022 filed Apr. 18, 2014, and claiming priority from Japanese Application No. 2013-130782 filed Jun. 21, 2013, the disclosure of which is incorporated herein.

### TECHNICAL FIELD

The present invention relates to a rotational operation type switch wherein it is possible to switch a switching contact by rotationally operating an operation button, or it is possible to obtain signals different from one rotation position to another.

### BACKGROUND ART

FIG. 8 shows one described in PTL 1 as a heretofore known example of this kind of rotational operation type switch.

A rotational operation type switch 50 shown in FIG. 8 includes a rotary knob 52 which is rotatably supported on the upper end of a frame 51. The frame 51 is fastened and fixed to the mounting panel of an control board (not shown) by a fastening nut 53. A rotating cylinder 55 linked to the rotary knob 52 is rotatably housed in the frame 51, and a cylindrical cam 56 is linked to the lower end of the rotating cylinder 55. A contact unit 57 is linked to the lower end of the frame 51. The leading end of a push bar 58 which operates and switches the contact of the contact unit 57 abuts against the cam surface of the cylindrical cam 56.

The rotary knob 52 is structured so as to be rotationally operable by inserting an operation key 60 therein in order to prevent an unintended rotational operation.

When operating the rotational operation type switch 50 structured in this way, the operation key 60 is inserted into the rotary knob 52, and the key 60 is rotationally operated in a right or left direction. The rotary knob 52 rotates with the rotation of the key 60, in conjunction with which the rotating cylinder 55 and the cylindrical cam 56 rotate. The push bar 58 is moved up and down in response to a change in position of the cam surface by the rotation of the cylindrical cam 56, and a contact mechanism 59 of the contact unit 57 is driven by the lower end of the push bar 58, thus switching (on and off) the contact.

This kind of heretofore known rotational operation type switch is formed such that the contact of the contact unit 57 can be switched by rotationally operating the rotary knob 52, but is structured by the contact unit and an operation mechanism which operates the contact unit being completely unitized and linked to each other in an axial direction. Therefore, there is the problem of an inevitable increase in the depth dimension of the switch from the operation surface of the switch. Also, when structuring the switch as a rotary selector switch, it is necessary to annex a number of contact mechanisms corresponding to the number of contact mechanisms to be selected, meaning that there is also the problem of an increase in the price of the switch as well as an increase in the overall size of the switch.

### CITATION LIST

### Patent Literature

PTL 1: Japanese Patent No. 3,936,433

### SUMMARY OF INVENTION

### Technical Problem

The invention, in order to solve the heretofore described problems of the heretofore known rotational operation type switch, has an object to provide a thin, miniature, and inexpensive rotational operation type switch, which is small in depth dimension from the operation surface of the switch, wherein it is possible to switch a switching contact mechanism by rotationally operating an operation button.

### Solution to Problem

The invention, in order to achieve the heretofore described object, is provided with a rotational operation button supported on a frame so as to be rotationally operable; and one switching contact mechanism disposed below the operation button to face the operation button. In the switch, an operation mechanism, including a cam, which operates and switches the switching contact mechanism in conjunction with the rotational operation of the operation button, is provided between the operation button and the switching contact mechanism.

In the invention, the switching operation mechanism can be structured so as to operate and switch (on and off) the switching contact mechanism once for each rotation of the operation button through a predetermined rotation angle, and operate and switch (on and off) the switching contact mechanism for a plurality of times for one revolution of the operation button.

It is preferable that the switching contact mechanism includes a plurality of fixed contact electrodes, disposed on a printed circuit board so as to be spaced for a predetermined distance away from each other, and a disc spring shaped movable contact, disposed bridging between the plurality of fixed contact electrodes, which changes in shape by being pressed, and contacts to and separate from the fixed contact electrodes, thus switching the electrical connection between the fixed contact electrodes.

It is preferable that the operation mechanism includes an annular cam, of which a cam surface undulating in a circumferential direction is formed in the rear surface of the operation button so as to face the switching contact mechanism, and a push bar which, by being urged by a spring, brings one end face into abutment with the cam surface and operates the switching contact mechanism with the other end face.

Also, a plurality of engagement holes which engages a locking member is provided on the rear surface of the operation button, one for each predetermined rotation angle, and a locking member holding portion which holds the locking member via a spring is provided in one position on the frame which can engage the engagement holes of the operation button, thus enabling a range of rotation to be easily confirmed.

Furthermore, finger-hook holes are provided on the front surface of the operation button, one for each of rotation angles corresponding to those of the engagement holes, thus enabling the operation button to be easily rotationally operated.

Also, a switching contact mechanism switching detection circuit which counts the number of times to switch the switching contact mechanism is connected to the switching contact mechanism, thus distinguishing the rotational operation amounts of the operation button.

### Advantageous Effects of Invention

The rotational operation type switch of the invention, as it is formed from a rotationally operable operation button supported on a frame, one switching contact mechanism, which is disposed facing the lower surface of the operation button, and an operation mechanism, including a rotary cam, which operates and switches the switching contact mechanism in conjunction with the rotational operation of the operation button, can be made thin and miniature.

### BRIEF DESCRIPTION OF DRAWINGS

FIGS. 1(a), 1(b) show a structure of a rotational operation type switch of an embodiment of the invention, wherein FIG. 1(a) is a plan view, and FIG. 1(b) is a vertical sectional view along the line A-A in FIG. 1(a).

FIG. 2 is an exploded perspective view showing a structure of the rotational operation type switch of the embodiment of the invention.

FIGS. 3(a), 3(b) show a structure of an operation button used in the rotational operation type switch of the invention, wherein FIG. 3(a) is an elevation view, and FIG. 3(b) is a rear view.

FIG. 4 is a developed vertical sectional view showing an embodiment of a cam formed in the rear surface of the operation button of the rotational operation type switch of the invention.

FIGS. 5(a), 5(b) show a condition in which the rotational operation type switch of the invention is mounted in a mounting panel, wherein FIG. 5(a) is a diagram showing a condition in which the rotational operation type switch is inserted in the mounting panel, and FIG. 5(b) is a diagram showing a condition in which the rotational operation type switch is fixed in the mounting panel.

FIGS. 6(a)-6(c) are illustrations of an operation of the rotational operation type switch of the invention.

FIG. 7 is a function comparison diagram of a heretofore known rotational operation type switch and the rotational operation type switch of the invention.

FIG. 8 is an elevation view including a partial section showing a structure of the heretofore known rotational operation type switch.

### DESCRIPTION OF EMBODIMENTS

Embodiments according to the invention will be described in detail with reference to the drawings.

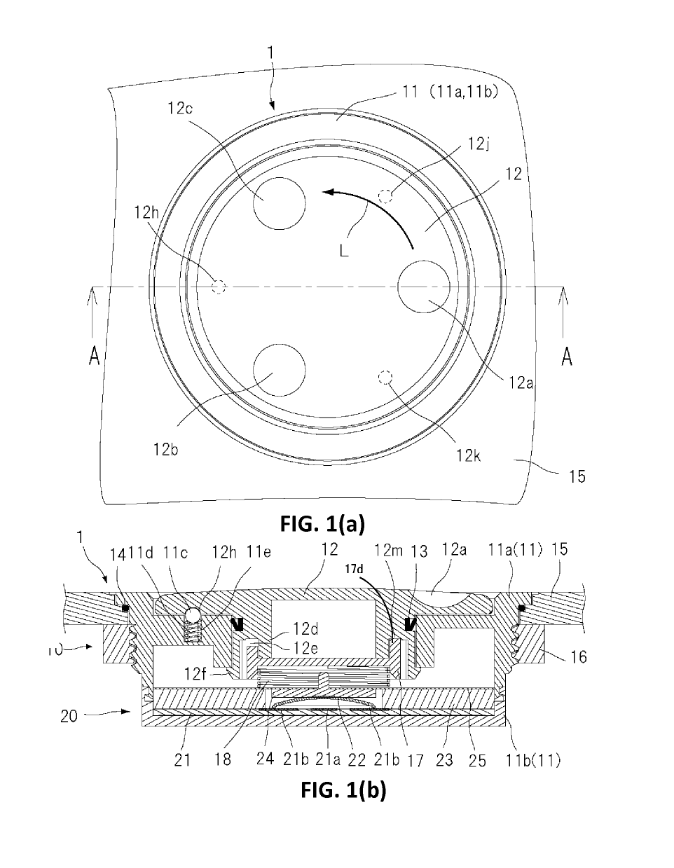

FIGS. 1(a) to 6(c) show an embodiment of a rotational operation type switch of the invention.

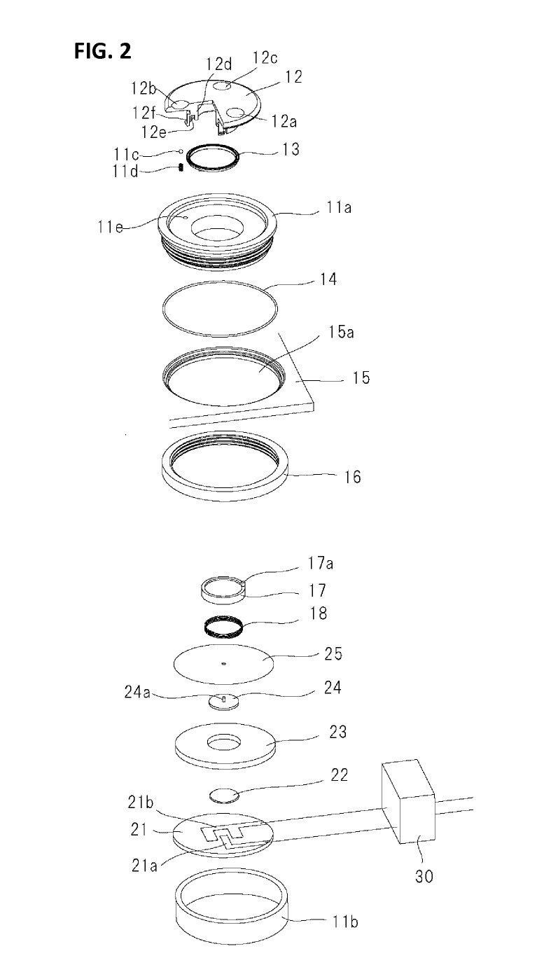

In FIGS. 1(a) and 2, reference 1 is a rotational operation type switch (hereafter sometimes simply called a switch). The switch 1 includes an integrated cup-shaped main body frame 11 into which halved upper frame 11a and lower frame 11b are linked together.

An operation section 10 is structured by inserting an operation button 12 into the upper frame 11a of the main body frame 11 via a packing 13 for preventing dust or water from intruding from the external. The operation button 12 inserted in the upper frame 11a is joined onto the upper frame 11a by engaging an engagement piece 12f of the operation button 12 with one portion of the upper frame 11a. By so doing, the operation button 12 is rotatably supported by the engagement piece 12f without disengaging from the upper frame 11a. Three finger-hook depressed portions 12a, 12b, and 12c are provided on the front surface of the operation button 12 at intervals of a predetermined rotation angle, herein, 120° in order to rotationally operate the operation button 12 with a finger hooked in the depressed portion.

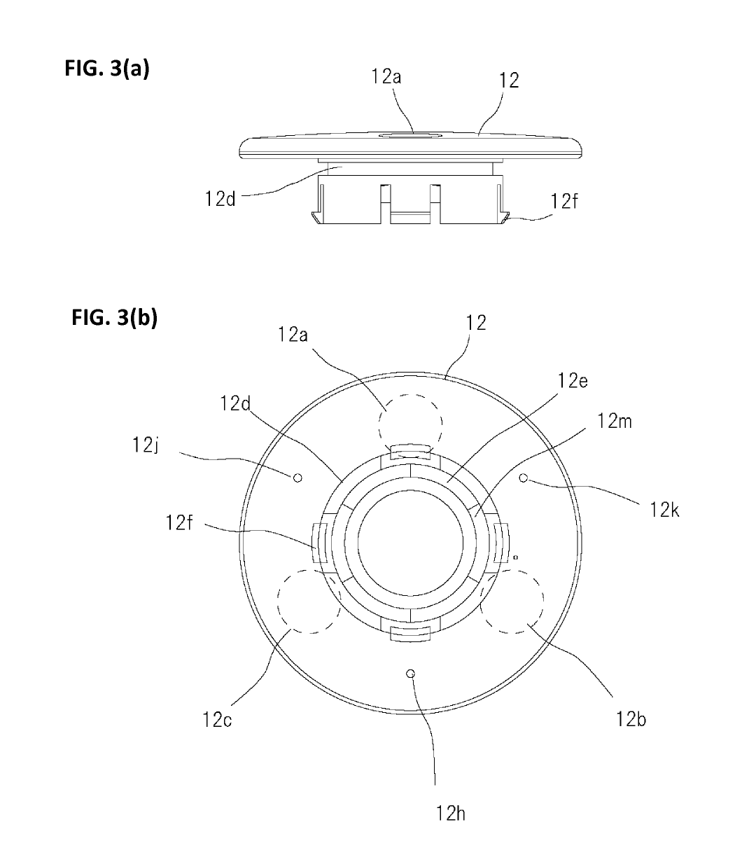

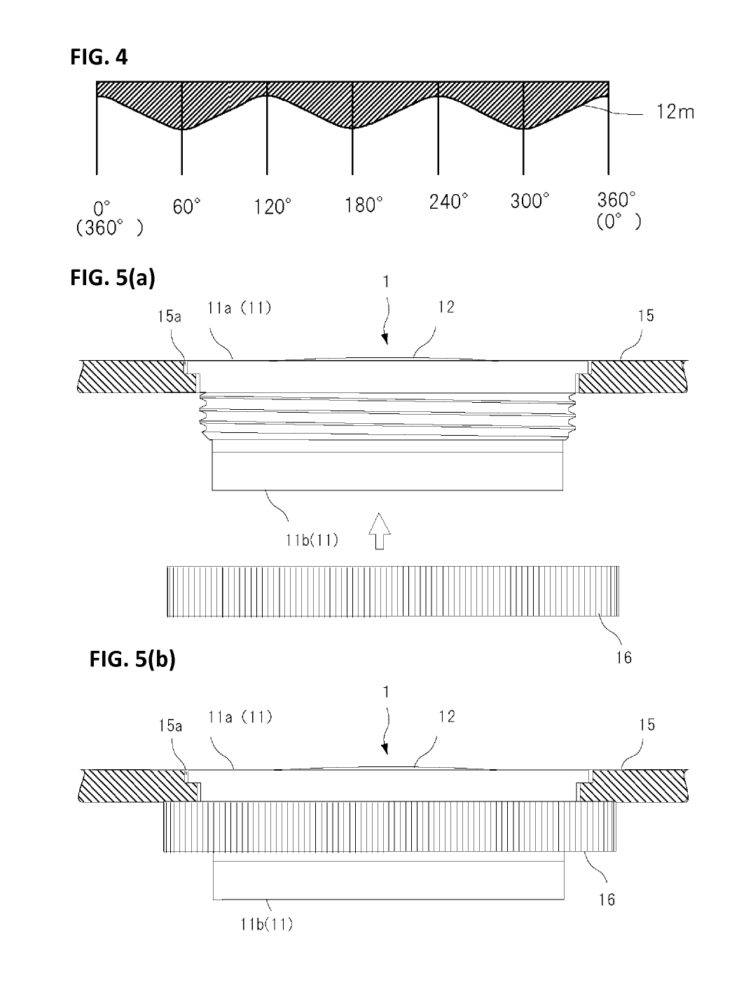

A cylindrical guide 12d is formed protruding on the rear surface side of the operation button 12, and an annular cam surface 12m, formed of an undulating surface continuing in a circumferential direction, is formed on the groove bottom of an annular groove 12e provided in the cylinder of the cylindrical guide 12d (refer to FIGS. 3(a) and 3(b)). The cam surface 12m is formed of an undulating surface having a waveform which forms trough portions in 0°, 120°, and 240° positions at intervals of 120°, and peak portions in 60°, 180°, and 300° positions out of phase with the trough portions by 60°, within the range of one revolution (360°), as shown in FIG. 4.

A push bar 17 formed in a cylindrical shape is loosely fitted in the annular groove 12e on which is formed the annular cam surface 12m of the cylindrical guide 12d on the rear surface side of the operation button 12. One protrusion 17a to abut the annular cam surface 12m of the cylindrical guide 12d is formed on the upper end face of the push bar 17. As the push bar 17 is urged upward from downward by a push bar urging spring 18 in an assembled condition, as shown in FIG. 1(b), the protrusion 17a on the upper end face is always abutting the annular cam surface 12m of the cylindrical guide 12d.

Three locking holes 12h, 12j, and 12k are further provided, at intervals of the same rotation angle (120°) as that of the finger-hook depressed portions 12a, 12b, and 12c, on the rear surface of the operation button 12 in order to reliably keep a predetermined operation position of the operation button. A holding hole 11e for holding a locking member formed from a locking ball 11c and a holding spring 11d which holds the locking ball 11c is provided in a position on the upper frame 11a, which is a rotation angle determination reference, so as to correspond to the locking hole 12h of the operation button 12. When the operation button 12 is rotationally operated, and one of the locking holes 12h, 12j, and 12k of the operation button 12 comes to a position on the upper frame 11 facing the holding hole 11e, the locking ball 11c is pushed into one of the locking holes 12h to 12k by the holding spring 11d, meaning that the operation button 12 is locked in the position.

Meanwhile, a printed circuit board 21, which includes a conductor pattern forming a plurality of fixed contact electrodes 21a and 21b, a circular, disc spring shaped movable contact piece 22, a distance keeping insulating liner 23, a push plate 24, and a protective flexible insulating sheet 25 are inserted in order into the lower frame 11b of the main body frame 11, and disposed, stacked one on another, on the bottom wall of the lower frame 11b, thereby forming a switching contact mechanism 20, as shown in FIG. 1(b). The lower frame 11b housing the switching contact mechanism 20 in this way is fitted on the lower end side of the upper frame 11a in which the operation section is formed, and the lower frame 11b and the upper frame 11a are linked together by appropriate joining means such as a male/female engagement mechanism.

When mounting the switch 1, assembled in this way, in amounting panel 15 of a control board or the like, as shown in FIG. 5(a), the switch 1 is inserted into a mounting through hole 15a, which is provided in the panel 15, from the front side of the panel 15, and is fixed in the panel 15 by screwing a fastening nut 16 onto the switch 1 from the rear surface side of the panel 15 and fastening the fastening nut 16 to the panel 15. By so doing, the switch 1 is mounted and fixed in the mounting panel 15, as shown in FIG. 5(b).

With the switch 1 of the invention, switching detection means 30 structured from an electronic circuit which detects an electrical connection between the fixed contact electrodes 21a and 21b provided on the printed circuit board 21 is prepared, as shown in FIG. 2, in order to detect a switching operation of the switching contact mechanism 20, and by connecting the switching detection means 30 to the fixed contact electrodes 21a and 21b, it is possible to detect a rotation position of the operation button 12 from an output of the switching detection means 30, and thus possible to apply the switch 1 to a selector switch or the like.

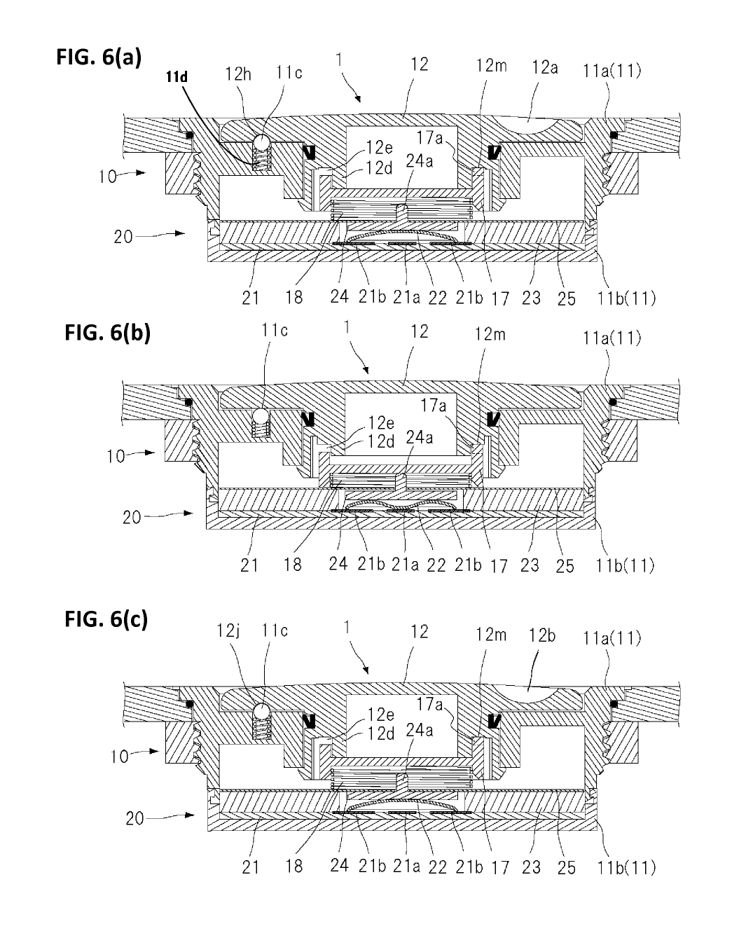

Next, a description will be given, referring to FIGS. 6(a)-6(c), of an operation of the thus structured switch 1 of the invention.

Herein, a position of the operation button 12 when the finger-hook depressed portion 12a is in the three o'clock position, as shown in FIG. 1(a), is set to a reference position (a rotation angle 0° position).

FIG. 6(a) shows a condition of the switch 1 when the operation button 12 is placed in the reference position. In the condition, as the push bar 17 of the switch 1 is pushed up by the spring 18 until the protrusion 17a of the push bar 17 contacts the trough portion in the 0° position of the cam surface 12m shown in FIG. 4, the push bar 17 is separated from the push plate 24. Therefore, the disc spring shaped movable contact piece 22 is curved upward, and the outer peripheral end of the movable contact piece 22 contacts only one fixed contact electrode 21b, meaning that the electrical connection between the fixed contact electrodes 21a and 21b becomes a disconnected (off) state.

In this condition, as the locking ball 11c is pushed up by the locking spring 11d, the ball 11c fits into the locking hole 12h on the rear surface of the operation button 12, and locks and fixes the operation button 12, thus preventing the operation button 12 from being casually rotated.

Next, FIG. 6(b) shows a condition when the operation button 12 is rotated 60° from the original position in the process of being rotationally operated one pitch (120°) in the arrow L (counterclockwise) direction in FIG. 1(a).

At this time, as the protrusion 17a of the push bar 17 comes to the position (the 60° position in FIG. 4) which is the peak portion of the cam surface of the cylindrical guide 12d, the push bar 17 is pushed down by the peak portion of the cam surface. As the push plate 24 is pushed down as a result of this, the disc spring shaped movable contact piece 22 is pressed and changed into a form in which the central portion of the movable contact piece 22 is depressed. By so doing, the central portion of the movable contact piece 22 contacts the fixed contact electrode 21a on the printed circuit board 21, meaning that the fixed contact electrodes 21a and 21b are electrically connected by the movable contact piece 22, and the electrical connection between the two fixed contact electrodes becomes a connected (on) state.

In an initial position of rotational operation of the operation button 12, as the operation button 12 is in a condition in which the locking ball 11c is in engagement with the locking hole 12h of the operation button 12, it is necessary to rotationally operate the operation button 12 using a little greater force with a fingertip hooked in the finger-hook depressed portion 12a. As the locking ball 11c is pushed in against the urging force of the spring 11d by the inclined surface of the locking hole 12h as a result of the rotational operation, and disengages the locking hole 12h, it is thereafter possible to continue the rotational operation using a small force.

When the operation button 12 is rotated 120°, and the next finger-hook depressed portion 12b rotates to the three o'clock position, the locking ball 11c engages the next locking hole 12j of the operation button 12, and it is possible to reliably lock the operation button 12 in one pitch's worth of rotation position (refer to FIG. 6(c)).

The switch 1 is formed such that in this position, the annular cam surface 12m in the cylindrical guide 12d rotates, and the cam surface which is the trough portion in the 120° position in FIG. 4 contacts the protrusion 17a of the push bar 17. Therefore, as shown in FIG. 6(c), the push bar 17 is pushed up by the spring 18 and separated from the push plate 24, as a result of which there is no more pressing force applied to the disc spring shaped movable contact piece 22, meaning that the movable contact piece 22 returns to the original shape in which the movable contact piece 22 is curved upward, and the electrical connection between the two fixed contact electrodes 21a and 21b becomes a disconnected (off) state.

In this way, when the operation button 12 is rotationally operated one fixed pitch (120°), the switching contact mechanism 20 performs the operation of turning from OFF to ON only once and back to OFF again. When the operation button 12 is rotationally operated two pitches, the switching contact mechanism 20 exhibits on-state twice.

Further, when the operation button 12 is rotationally operated three pitches (operated one revolution), the switching contact mechanism 20 exhibits on-state three times. Therefore, the number of times the switching contact mechanism 20 becomes on-state for every one rotational operation of the operation button 12 is counted by the switching detection means 30, shown in FIG. 2, which monitors the switching condition of the switching contact mechanism 20, thereby enabling knowing of the rotation pitch and thus rotation position of the operation button 12, and a structure is adopted such as to output signals different from pitch to pitch, thereby enabling the switch 1 to be provided with a function equivalent to a selector switch.

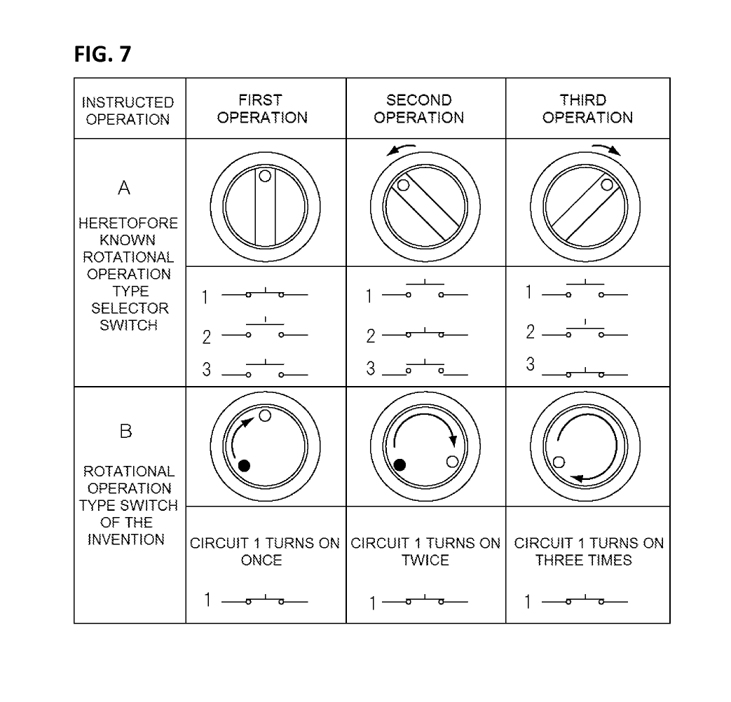

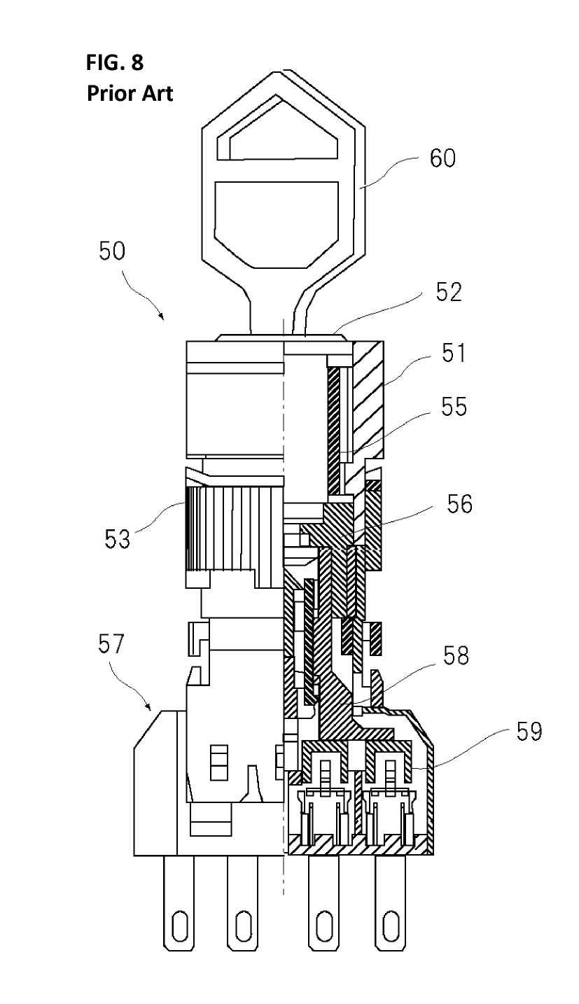

A comparison of an operation of this kind of rotational operation type switch of the invention with an operation of a heretofore known rotational operation type selector switch is shown in FIG. 7 as a function comparison diagram.

Each of the two switches can select three operations. Therefore, a heretofore known switch A includes a rotary knob, which enables selection of three positions by being rotationally operated, and three contact circuits 1, 2, and 3.

The heretofore known selector switch is formed such that when a first operation position is selected with the rotary knob, the contact circuit 1 turns on, and the other two contact circuits turn off, as shown in the A column. When a second operation position is selected by rotating the rotary knob, the contact circuit 2 turns on, and the other two contact circuits turn off. Furthermore, when a third operation position is selected by rotating the rotary knob, the contact circuit 3 turns on, and the other two contact circuits turn off.

In contrast, the switch of the invention is similar to the heretofore known selector switch in that three positions are selected by rotating the operation button through one predetermined rotation angle for each position selection, but the switch of the invention includes only one contact circuit.

The switch of the invention is formed such that when a first operation of rotating the operation button from a first operation position to a second operation position is carried out, the contact circuit turns on once, as shown in the B column. When a second operation of rotating the operation button from the first operation position to a third operation position is carried out, the contact circuit turns on twice. Furthermore, when a third operation of rotating one revolution from the first operation position to the first operation position is carried out, the contact circuit turns on three times, and it is thereby possible to obtain three different output signals in the same way as in the heretofore known selector switch which selects three positions.

In the above, an example wherein the operation button is rotationally operated at pitches of 120° has been shown, but in the invention, the rotation pitch angle of the operation button, not being limited to this, can be optionally set.

### REFERENCE SIGNS LIST

1: Rotational operation type switch
11: Main body frame
11a: Upper frame
11b: Lower frame
11c: Locking ball (locking member)
12: Rotational operation button
12a, 12b, 12c: Finger-hook depressed portion
12d: Cylindrical guide
12e: Annular groove
12m: Annular cam surface
12h, 12j, 12k: Locking hole
17: Push bar
18: Push bar biasing spring
20: Switching contact mechanism
21: Printed circuit board
21a, 21b: Fixed contact electrode
22: Movable contact piece
24: Push plate
30: Switching contact mechanism switching detection means

What is claimed is:

1. A rotational operation type switch, comprising:
a frame;
a rotational operation button rotatably supported on the frame for rotational operation;
a switching contact mechanism disposed below the operation button to face the operation button; and
an operation mechanism including a cam, and disposed between the operation button and the switching contact mechanism, to switch the switching contact mechanism in conjunction with the rotational operation of the operation button,
wherein the switching contact mechanism includes a printed circuit board, a plurality of fixed contact electrodes disposed on the printed circuit board and spaced at a predetermined distance away from each other, and a movable contact having a disc spring shape and disposed bridging between the plurality of fixed contact electrodes, and
the movable contact deforms to contact with and separate from the plurality of fixed contact electrodes and switches an electrical connection between the plurality of fixed contact electrodes.

2. The rotational operation type switch according to claim 1, wherein the operation mechanism is structured to switch the switching contact mechanism one time for each rotation of the operation button for a predetermined rotation angle, and to switch the switching contact mechanism for a plurality of times for one revolution of the operation button.

3. The rotational operation type switch according to claim 1, wherein the operation mechanism includes:
an annular cam formed with a cam surface on a rear surface of the operation button to face the switching contact mechanism, the cam surface undulating in a circumferential direction of the operation button, and
a push bar urged by a spring so that one end face thereof abuts against the cam surface and another end face thereof operates the switching contact mechanism.

4. The rotational operation type switch according to claim 1, further comprising:
a plurality of locking holes each being formed on a rear surface of the operation button at a predetermined rotation angle,
a locking member to engage with the plurality of locking holes, and
a locking member holding portion holding the locking member through a spring provided at one position of the frame to engage the plurality of locking holes of the operation button.

5. The rotational operation type switch according to claim 4, wherein a front surface of the operation button is provided with finger-hook holes, and
each of the finger-hook holes is formed at a rotation angle corresponding to that of each of the plurality of locking holes.

6. The rotational operation type switch according to claim 1, further comprising a switching contact mechanism switching detection circuit connected to the switching contact mechanism, for counting number of switching of the switching contact mechanism and distinguishing rotational operation amounts of the operation button.
